(19) United States
(12) Patent Application Publication
(10) Pub. No.: US 2025/0286356 A1
(43) Pub. Date: Sep. 11, 2025

(54) WATERPROOF STRUCTURE AND WIRE HARNESS

(71) Applicant: Yazaki Corporation, Tokyo (JP)

(72) Inventors: Tomohiro URASHIMA, Tochigi (JP); Hiroyasu FURUYA, Tochigi (JP); Yu SUGAWARA, Tochigi (JP)

(73) Assignee: Yazaki Corporation, Tokyo (JP)

(21) Appl. No.: 19/215,777

(22) Filed: May 22, 2025

Related U.S. Application Data
(63) Continuation of application No. PCT/JP2024/010400, filed on Mar. 18, 2024.

(30) Foreign Application Priority Data
Apr. 19, 2023 (JP) 2023-068297

(51) Int. Cl. H02G 3/06; H02G 3/04

(52) U.S. Cl. CPC H02G 3/06; H02G 3/0468

(57) ABSTRACT

A waterproof structure includes: a corrugated tube into which an electric wire is inserted; and a grommet having a first tubular portion into which the corrugated tube is inserted and holding the corrugated tube, in which the first tubular portion includes a first seal portion that protrudes toward a central axis line of the first tubular portion and is in close contact with an outer peripheral surface of the corrugated tube, a second seal portion that protrudes toward the central axis line and is in close contact with the outer peripheral surface of the corrugated tube, and a flexible portion that is disposed between the first seal portion and the second seal portion and is bendable.

### CROSS-REFERENCE TO RELATED APPLICATION(S)

This application is a continuation of International Application No. PCT/JP2024/010400, filed on Mar. 18, 2024 which claims the benefit of priority of the prior Japanese Patent Application No. 2023-068297, filed on Apr. 19, 2023, the entire contents of which are incorporated herein by reference.

### BACKGROUND OF THE INVENTION

### 1. Field of the Invention

The present invention relates to a waterproof structure and a wire harness.

### 2. Description of the Related Art

Conventionally, there is a grommet attached to a corrugated tube. JP 2017-225339 A discloses a grommet including a tubular corrugated side end portion connectable to an outer peripheral side of a corrugated tube in a sealed state, and a plurality of sealing lips provided on an inner peripheral surface of the corrugated side end portion so as to be in close contact with a valley portion of the corrugated tube.

JP 2021-13253 A discloses a grommet including a grommet tubular portion, an inner tubular portion, an outer tubular portion, a binding member assembling portion, an outer tubular side holding portion, and an inner tubular side holding portion. The inner tubular portion is inserted into the corrugated tube from the end portion of the corrugated tube. The outer tubular portion is formed in a portion covering from the end portion of the corrugated tube to the outside.

In the waterproof structure having the corrugated tube and the grommet and the wire harness, it is desirable that the water-blocking performance can be improved. For example, it is preferable that the water-blocking performance can be improved in a case where the corrugated tube is routed while being bent.

### SUMMARY OF THE INVENTION

An object of the present invention is to provide a waterproof structure and a wire harness capable of improving water-blocking performance.

In order to achieve the above mentioned object, a waterproof structure according to one aspect of the present invention includes a corrugated tube into which an electric wire is inserted; and a grommet having a first tubular portion into which the corrugated tube is inserted and holding the corrugated tube, wherein the first tubular portion includes a first seal portion that protrudes toward a central axis line of the first tubular portion and is in close contact with an outer peripheral surface of the corrugated tube, a second seal portion that protrudes toward the central axis line and is in close contact with the outer peripheral surface of the corrugated tube, and a flexible portion that is disposed between the first seal portion and the second seal portion and is bendable, a crest portion of the corrugated tube has a top surface, a length of the first seal portion and the second seal portion in the direction of the central axis line is a length capable of covering two adjacent top surfaces of the corrugated tube, the grommet includes a fitting portion fitted to a through hole of a panel, and the fitting portion is disposed on a side opposite to a side of the first seal portion with respect to the second seal portion, and a length of the first seal portion in the direction of the central axis line is larger than a length of the second seal portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a waterproof structure and a wire harness according to an embodiment;

FIG. 2 is a plan view of the waterproof structure and the wire harness according to the embodiment;

FIG. 3 is an exploded perspective view of the waterproof structure according to the embodiment;

FIG. 4 is a cross-sectional view of a grommet according to the embodiment;

FIG. 5 is a cross-sectional view of a corrugated tube according to the embodiment;

FIG. 6 is a cross-sectional view of the waterproof structure according to the embodiment;

FIG. 7 is a cross-sectional view of the waterproof structure according to the embodiment;

FIG. 8 is a cross-sectional view of the waterproof structure according to the embodiment;

FIG. 9 is a cross-sectional view of a grommet and a corrugated tube that are bent and deformed; and

FIG. 10 is a view illustrating a waterproof structure and a wire harness according to a first modification of the embodiment.

### DETAILED DESCRIPTION OF THE PREFERRED EMBODIMENTS

Hereinafter, a waterproof structure and a wire harness according to an embodiment of the present invention will be described in detail with reference to the drawings. Note that the present invention is not limited by the embodiment. In addition, constituent elements in the following embodiments include those that can be easily assumed by those skilled in the art or those that are substantially the same.

### Embodiment

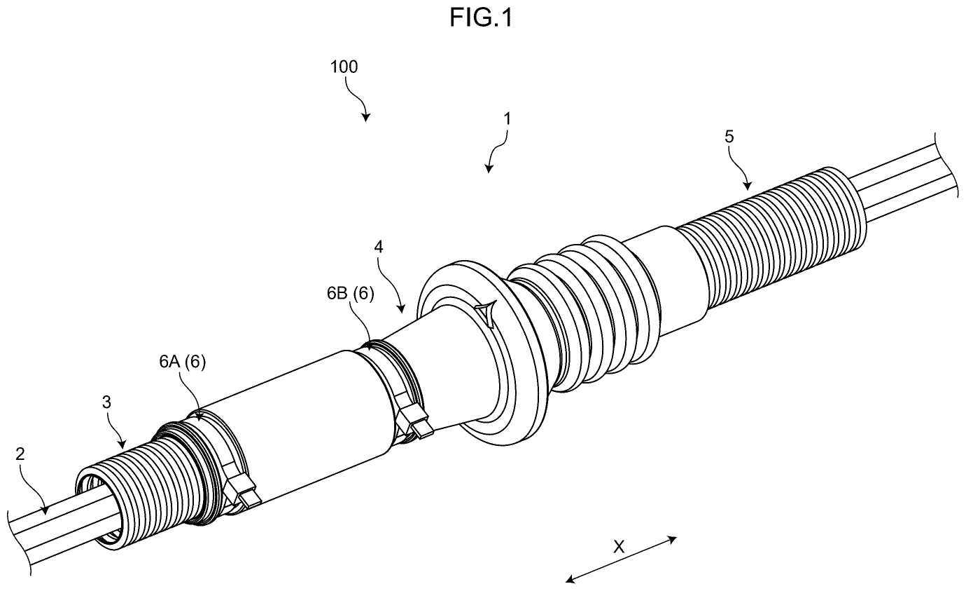

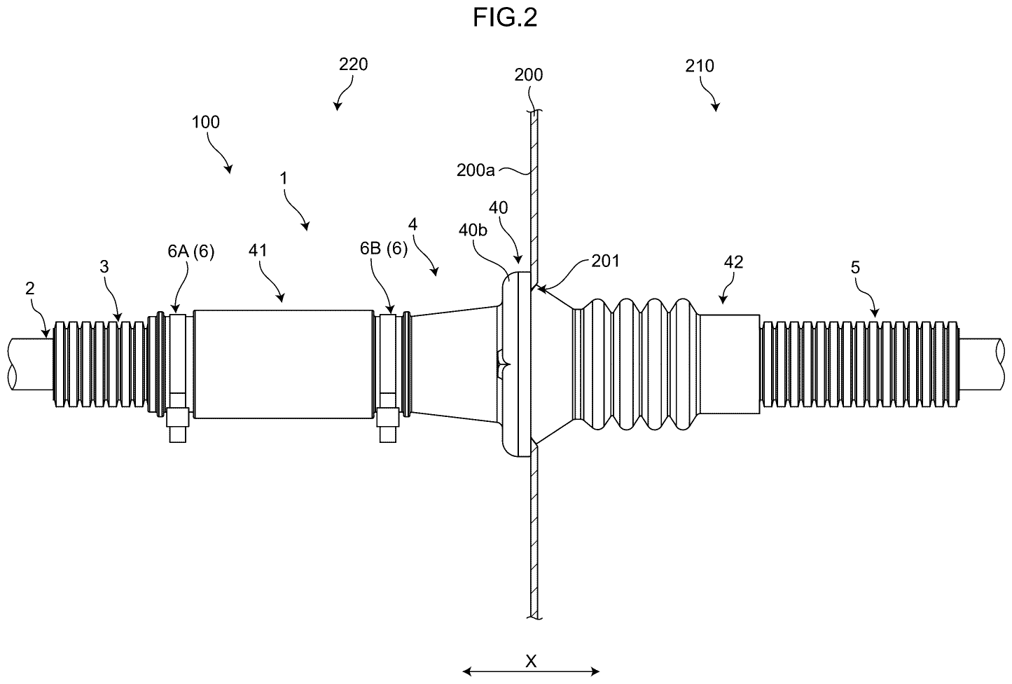

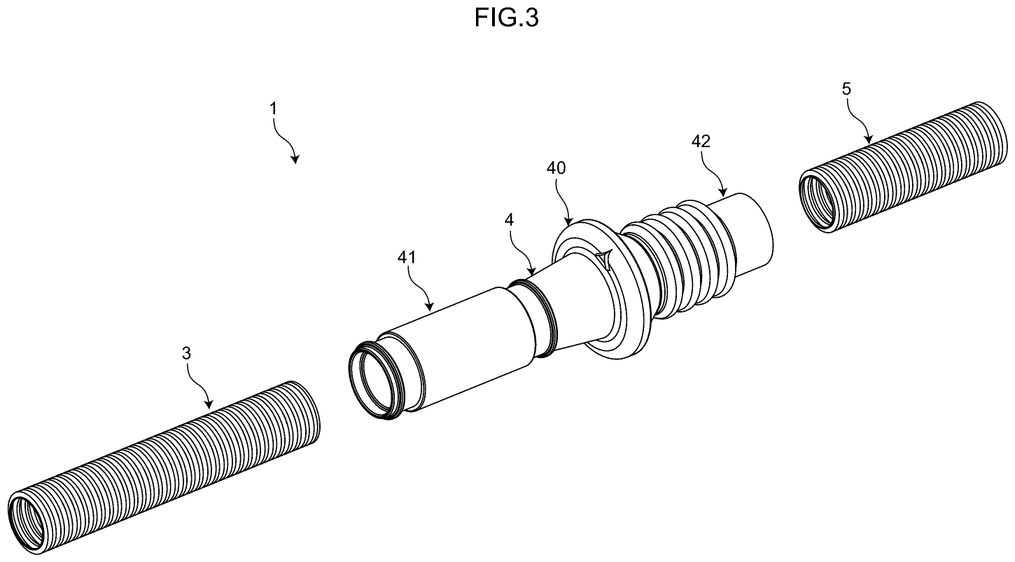

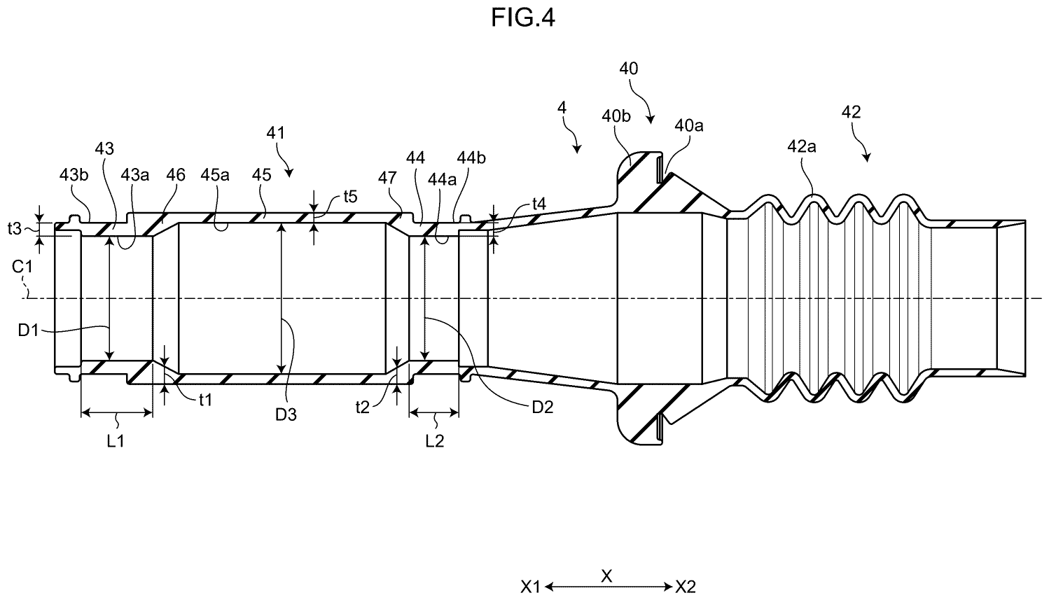

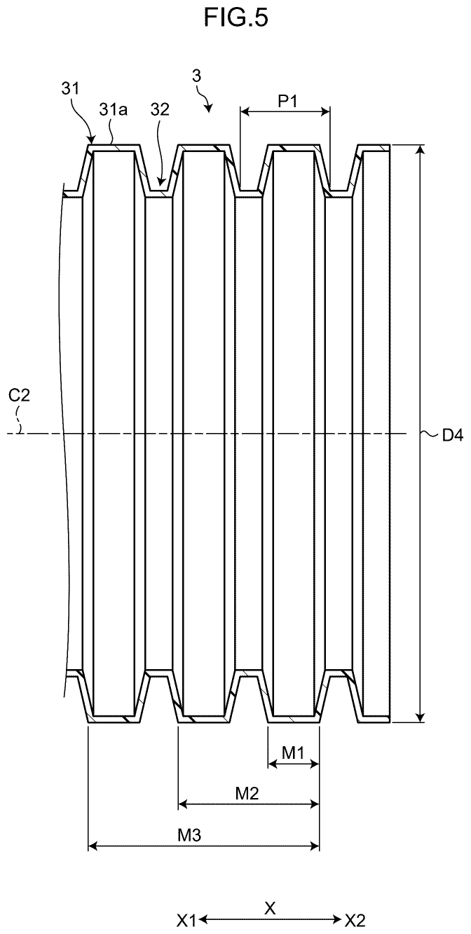

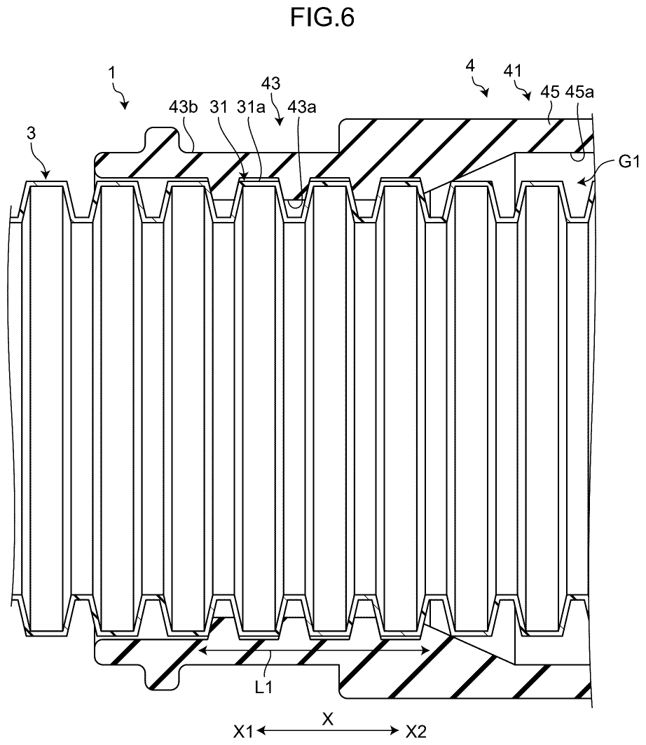

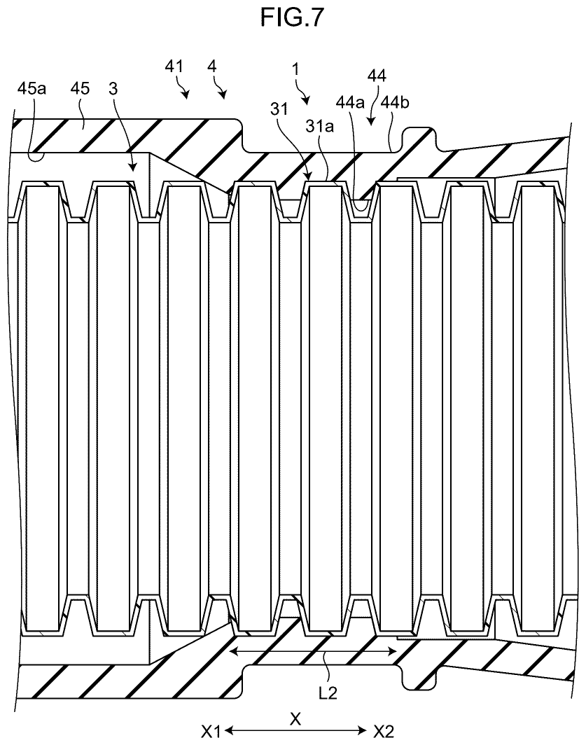

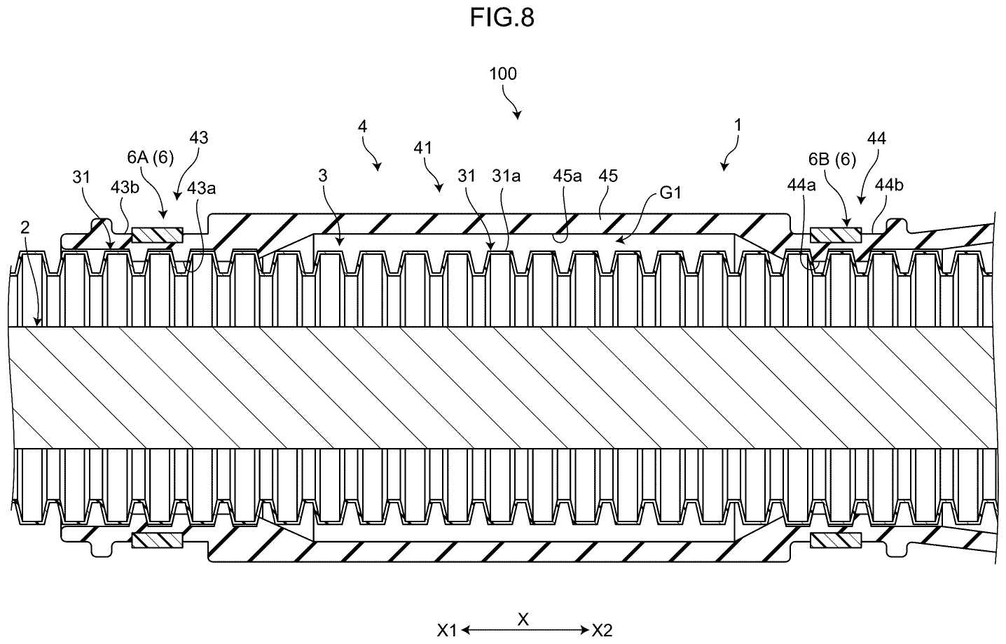

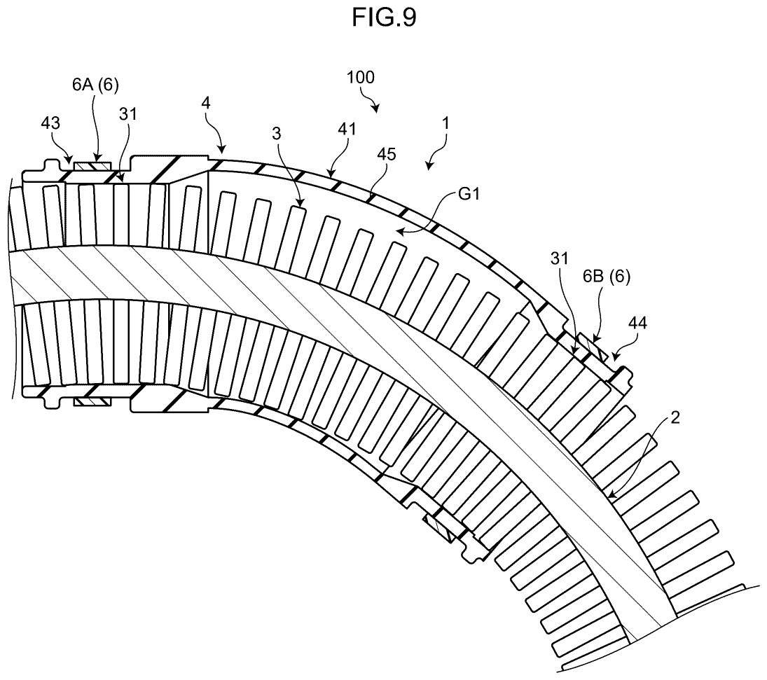

An embodiment will be described with reference to FIGS. 1 to 9. The present embodiment relates to a waterproof structure and a wire harness. FIG. 1 is a perspective view of a waterproof structure and a wire harness according to an embodiment; FIG. 2 is a plan view of the waterproof structure and the wire harness according to the embodiment; FIG. 3 is an exploded perspective view of the waterproof structure according to the embodiment; FIG. 4 is a cross-sectional view of a grommet according to the embodiment; FIG. 5 is a cross-sectional view of a corrugated tube according to the embodiment; FIG. 6 is a cross-sectional view of the waterproof structure according to the embodiment; FIG. 7 is a cross-sectional view of the waterproof structure according to the embodiment; FIG. 8 is a cross-sectional view of the waterproof structure according to the embodiment; and FIG. 9 is a cross-sectional view of a grommet and a corrugated tube that are bent and deformed.

As illustrated in FIG. 1, a wire harness 100 of the present embodiment includes a waterproof structure 1 and an electric wire 2. The wire harness 100 is mounted on a vehicle such as an automobile, for example. The waterproof structure 1 includes a corrugated tube 3, a grommet 4, an exterior member 5, and a band member 6. The waterproof structure 1 of the present embodiment can appropriately suppress the infiltration of water from the gap between the corrugated tube 3 and the grommet 4.

As illustrated in FIG. 2, the grommet 4 is fitted to a panel 200. The panel 200 is, for example, a metal plate that partitions a vehicle interior space 210 and an external space 220 of the vehicle. The panel 200 has a through hole 201 into which the grommet 4 can be inserted. The grommet 4 is inserted into the through hole 201 and is in close contact with a wall surface 200a of the panel. In the present specification, the axial direction of the grommet 4 is referred to as a “first direction X”. The grommet 4 penetrates the panel 200 along the first direction X.

The corrugated tube 3 is a flexible exterior member and has a bellows shape. The corrugated tube 3 has a cylindrical shape, and both ends in the axial direction are open. The corrugated tube 3 of the present embodiment does not have a slit. Therefore, the cross-sectional shape of the corrugated tube 3 in the cross section orthogonal to the axial direction is an endless circular shape. The exterior member 5 of the present embodiment is a member similar to the corrugated tube 3 and has flexibility. The grommet 4 is a waterproof member and is molded using an elastically deformable resin such as rubber. The grommet 4 has higher flexibility than the corrugated tube 3.

As illustrated in FIG. 3, the grommet 4 includes a fitting portion 40, a first tubular portion 41, and a second tubular portion 42. The fitting portion 40 is a portion fitted to the panel 200. The first tubular portion 41 is a portion into which the corrugated tube 3 is inserted, and the second tubular portion 42 is a portion into which the exterior member 5 is inserted. The exemplified first tubular portion 41 and the second tubular portion 42 have a cylindrical shape.

As illustrated in FIG. 4, the fitting portion 40 has an annular groove portion 40a and an outer seal portion 40b. The groove portion 40a is provided on the outer peripheral surface of the grommet 4. The groove portion 40a is recessed along the radial direction of the grommet 4 toward a central axis line C1 of the grommet 4. The panel 200 is fitted into the groove portion 40a. The outer seal portion 40b protrudes in a flange shape outward in the radial direction with respect to the groove portion 40a. The outer seal portion 40b faces the wall surface 200a of the panel 200 in the first direction X and is in close contact with the wall surface 200a.

The first tubular portion 41 is disposed on a first side X1 in the first direction X with respect to the fitting portion 40, and the second tubular portion 42 is disposed on a second side X2 in the first direction X with respect to the fitting portion 40. In other words, the fitting portion 40 is disposed between the first tubular portion 41 and the second tubular portion 42.

The first tubular portion 41 includes a first seal portion 43, a second seal portion 44, a flexible portion 45, a first tapered portion 46, and a second tapered portion 47. The first seal portion 43 is disposed at an end portion of the first tubular portion 41 on a side far from the fitting portion 40. The second seal portion 44 is disposed between the first seal portion 43 and the fitting portion 40. In addition, the flexible portion 45 is disposed between the first seal portion 43 and the second seal portion 44. That is, the first seal portion 43 is disposed on the first side X1 with respect to the flexible portion 45, and the second seal portion 44 is disposed on the second side X2 with respect to the flexible portion 45. The first tapered portion 46 is disposed between the first seal portion 43 and the flexible portion 45, and the second tapered portion 47 is disposed between the second seal portion 44 and the flexible portion 45.

The first seal portion 43 and the second seal portion 44 are formed so as to be in close contact with the outer peripheral surface of the corrugated tube 3. The first seal portion 43 and the second seal portion 44 have a cylindrical shape. The first seal portion 43 has a seal surface 43a in close contact with the outer peripheral surface of the corrugated tube 3. The second seal portion 44 has a seal surface 44a in close contact with the outer peripheral surface of the corrugated tube 3. The first seal portion 43 and the second seal portion 44 protrude toward the central axis line C1 of the first tubular portion 41.

More specifically, the seal surface 43a of the first seal portion 43 protrudes toward the side of the central axis line C1 with respect to an inner peripheral surface 45a of the flexible portion 45. The seal surface 44a of the second seal portion 44 protrudes toward the side of the central axis line C1 with respect to the inner peripheral surface 45a of the flexible portion 45. The value of an inner diameter D1 of the first seal portion 43 is, for example, equal to the value of an inner diameter D2 of the second seal portion 44. The value of an inner diameter D3 of the flexible portion 45 is larger than the values of the inner diameters D1 and D2.

The seal surface 43a has a length L1, and the seal surface 44a has a length L2. The lengths L1 and L2 are lengths in the first direction X. In the grommet 4 of the present embodiment, the length L1 of the seal surface 43a of the first seal portion 43 is larger than the length L2 of the seal surface 44a of the second seal portion 44.

An annular groove 43b corresponding to the band member 6 is provided on the outer peripheral surface of the first seal portion 43. The groove 43b is disposed at the end portion of the first seal portion 43 on the first side X1. A thickness t3 from the bottom surface of the groove 43b to the seal surface 43a is larger than a thickness t5 of the flexible portion 45. An annular groove 44b corresponding to the band member 6 is provided on the outer peripheral surface of the second seal portion 44. A thickness t4 from the bottom surface of the groove 44b to the seal surface 44a is larger than the thickness t5 of the flexible portion 45.

The first tapered portion 46 connects the first seal portion 43 and the flexible portion 45 along the first direction X. A wall thickness t1 of the first tapered portion 46 decreases with increasing distance from the first seal portion 43 along the first direction X. The inner diameter of the first tapered portion 46 increases from the first seal portion 43 toward the flexible portion 45. That is, the inner peripheral surface of the first tapered portion 46 has a tapered shape in which the inner diameter decreases from the flexible portion 45 toward the first seal portion 43.

The second tapered portion 47 connects the flexible portion 45 and the second seal portion 44 along the first direction X. A wall thickness t2 of the second tapered portion 47 decreases with increasing distance from the second seal portion 44 along the first direction X. The inner diameter of the second tapered portion 47 increases from the second seal portion 44 toward the flexible portion 45. That is, the inner peripheral surface of the second tapered portion 47 has a tapered shape in which the inner diameter decreases from the flexible portion 45 toward the second seal portion 44.

The second tubular portion 42 has a cylindrical shape into which the exterior member 5 can be inserted. The second tubular portion 42 of the present embodiment includes a bellows portion 42a having a bellows shape.

As illustrated in FIG. 5, the corrugated tube 3 has a plurality of crest portions 31 and a plurality of valley portions 32. The crest portion 31 is a portion protruding outward in the radial direction. The valley portion 32 is a portion between the skirt of one crest portion 31 and the skirt of the other crest portion 31. In the corrugated tube 3, the crest portions 31 and the valley portions 32 are alternately arranged in the first direction X. The cross-sectional shape of the crest portion 31 in the cross section along a central axis line C2 is a trapezoidal shape. The crest portion 31 has a top surface 31a. The top surface 31a is an outer peripheral surface of the corrugated tube 3. The corrugated tube 3 has an outer diameter D4. The outer diameter D4 is a diameter of the top surface 31a. The value of the outer diameter D4 is determined by the following formulas (1) and (2). That is, the outer diameter D4 of the corrugated tube 3 is equal to or larger than the inner diameter D1 of the first seal portion 43 and equal to or larger than the inner diameter D2 of the second seal portion 44.

D4≥D1 (1)

D4≥D2 (2)

The inner diameter D1 of the first seal portion 43 and the inner diameter D2 of the second seal portion 44 may be determined so that the seal surfaces 43a and 44a can be in close contact with the outer peripheral surface of the corrugated tube 3 even in a case where permanent compressive strain occurs in the first tubular portion 41. In this case, the values of the inner diameters D1 and D2 are smaller than the outer diameter D4 of the corrugated tube 3.

The crest portions 31 are arranged at equal intervals at a pitch P1. The pitch P1 is the distance in the first direction X from the reference position of one valley portion 32 to the reference position of an adjacent valley portion 32. The reference position is, for example, a boundary line between the valley portion 32 and the crest portion 31.

The corrugated tube 3 has a first length M1, a second length M2, and a third length M3. The lengths M1, M2, and M3 are all lengths in the first direction X when the corrugated tube 3 extends linearly. The first length M1 is a width of the top surface 31a in the first direction X. The second length M2 is a length determined by two adjacent top surfaces 31a. In other words, the second length M2 is a distance from the end portion of one top surface 31a on the first side X1 to the end portion of one adjacent top surface 31a on the second side X2. The third length M3 is a length determined by three consecutive top surfaces 31a. In other words, the third length M3 is a distance from the end portion of the top surface 31a on the first side X1 to the end portion of the second adjacent top surface 31a on the second side X2.

The corrugated tube 3 is inserted into the first tubular portion 41 from the first seal portion 43 side, for example. The corrugated tube 3 is inserted into the grommet 4 at least to a position penetrating the second seal portion 44.

FIG. 6 illustrates the corrugated tube 3 inserted into the first seal portion 43. The first seal portion 43 is formed such that the seal surface 43a can be in close contact with the entirety of at least two adjacent top surfaces 31a. Specifically, the length L1 of the seal surface 43a of the first seal portion 43 is equal to or longer than the second length M2 illustrated in FIG. 5. In this case, by appropriately positioning the first seal portion 43 with respect to the corrugated tube 3, the seal surface 43a can be in close contact with the entire two adjacent top surfaces 31a. The length L1 of the present embodiment is larger than the second length M2. The length L1 of the seal surface 43a may be equal to or longer than the third length M3 illustrated in FIG. 5. In this case, the seal surface 43a can be in close contact with the entirety of at least two top surfaces 31a, and can also be in close contact with the entirety of three consecutive top surfaces 31a.

As illustrated in FIG. 6, the corrugated tube 3 may be inserted into the first seal portion 43 while elastically deforming the first seal portion 43. In this case, the value of the inner diameter D1 of the first seal portion 43 is smaller than the value of the outer diameter D4 of the corrugated tube 3. This increases the degree of close contact of the seal surface 43a with the outer peripheral surface of the corrugated tube 3.

FIG. 7 illustrates the corrugated tube 3 inserted into the second seal portion 44. The second seal portion 44 is formed such that the seal surface 44a can be in close contact with the entirety of at least two adjacent top surfaces 31a. Specifically, the length L2 of the seal surface 44a of the second seal portion 44 is equal to or longer than the second length M2 illustrated in FIG. 5. The length L2 of the present embodiment is larger than the second length M2.

As illustrated in FIG. 7, the corrugated tube 3 may be inserted into the second seal portion 44 while elastically deforming the second seal portion 44. In this case, the value of the inner diameter D2 of the second seal portion 44 is smaller than the value of the outer diameter D4 of the corrugated tube 3. This increases the degree of close contact of the seal surface 44a with the outer peripheral surface of the corrugated tube 3.

FIG. 8 illustrates the band member 6 fastened to the first tubular portion 41. The first seal portion 43 and the second seal portion 44 are in close contact with the outer peripheral surface of the corrugated tube 3 to hold the corrugated tube 3. A band member 6A is fastened to the groove 43b of the first seal portion 43. The band member 6A fastens the first seal portion 43 to the corrugated tube 3 and presses the seal surface 43a toward the outer peripheral surface of the corrugated tube 3. A band member 6B is fastened to the groove 44b of the second seal portion 44. The band member 6B fastens the second seal portion 44 to the corrugated tube 3 and presses the seal surface 44a toward the outer peripheral surface of the corrugated tube 3.

The width of the band member 6 is preferably larger than the first length M1 of the corrugated tube 3. The width of the band member 6 may be larger than a pitch P1 of the corrugated tube 3. In this case, the band member 6 can press the seal surfaces 43a and 44a against the two adjacent top surfaces 31a.

As illustrated in FIG. 8, a gap G1 is provided between the inner peripheral surface 45a of the flexible portion 45 and the outer peripheral surface of the corrugated tube 3. Therefore, in a case where the corrugated tube 3 is bent and deformed, the flexible portion 45 can easily follow the deformation of the corrugated tube 3 to be bent and deformed.

FIG. 9 illustrates the corrugated tube 3 and the grommet 4 which are bent and deformed. The first seal portion 43 is in close contact with the outer peripheral surface of the corrugated tube 3. Therefore, the first seal portion 43 can effectively suppress infiltration of water into the gap G1 from the outside of the grommet 4. The first seal portion 43 is fastened to the corrugated tube 3 by the band member 6A. Therefore, the displacement of the first seal portion 43 with respect to the corrugated tube 3 when the first tubular portion 41 follows the deformation of the corrugated tube 3 is suppressed, and the deterioration in sealability is suppressed.

The second seal portion 44 is in close contact with the outer peripheral surface of the corrugated tube 3. Therefore, the second seal portion 44 can effectively suppress infiltration of water into the fitting portion 40 side. The second seal portion 44 is fastened to the corrugated tube 3 by the band member 6B. Therefore, the displacement of the second seal portion 44 with respect to the corrugated tube 3 when the first tubular portion 41 follows the deformation of the corrugated tube 3 is suppressed, and the deterioration in sealability is suppressed.

As described above, in the waterproof structure 1 of the present embodiment, infiltration of water from the external space 220 into the vehicle interior space 210 is suppressed by the two seal portions 43 and 44. In addition, an elastically deformable flexible portion 45 is provided between the two seal portions 43 and 44. Therefore, the waterproof structure 1 of the present embodiment can achieve both followability of the grommet 4 to bending deformation of the corrugated tube 3 and securing of waterproof performance.

As described above, the waterproof structure 1 of the present embodiment includes the corrugated tube 3 into which the electric wire 2 is inserted and the grommet 4. The grommet 4 has a first tubular portion 41 into which the corrugated tube 3 is inserted, and holds the corrugated tube 3. The first tubular portion 41 includes the first seal portion 43, the second seal portion 44, and the bendable flexible portion 45. The first seal portion 43 and the second seal portion 44 protrude toward the central axis line C1 of the first tubular portion 41 and are in close contact with the outer peripheral surface of the corrugated tube 3. The flexible portion 45 is disposed between the first seal portion 43 and the second seal portion 44. Since the waterproof structure 1 of the present embodiment has the seal portions 43 and 44 on both sides of the flexible portion 45, it is possible to improve water-blocking performance.

In the waterproof structure 1 of the present embodiment, the crest portion 31 of the corrugated tube 3 has the top surface 31a. The length L1 of the first seal portion 43 and the length L2 of the second seal portion 44 in the direction of the central axis line C1 are lengths that can cover two adjacent top surfaces 31a. In this embodiment, the first seal portion 43 can entirely cover the two adjacent top surfaces 31a, and the second seal portion 44 can entirely cover the two adjacent top surfaces 31a. Therefore, the waterproof structure 1 of the present embodiment can improve water-blocking performance.

The grommet 4 of the present embodiment has the fitting portion 40 fitted to the through hole 201 of the panel 200. The fitting portion 40 is disposed on the side opposite to the first seal portion 43 side with respect to the second seal portion 44. The length L1 of the first seal portion 43 is larger than the length L2 of the second seal portion 44. That is, the waterproof structure 1 of the present embodiment can effectively stop water at the first seal portion 43 on the side far from the fitting portion 40.

In the waterproof structure 1 of the present embodiment, the first tapered portion 46 whose wall thickness changes is provided between the flexible portion 45 and the first seal portion 43. The wall thickness t1 of the first tapered portion 46 decreases with increasing distance from the first seal portion 43 along the direction of the central axis line C1. That is, the rigidity of the first tapered portion 46 increases from the flexible portion 45 toward the first seal portion 43. Therefore, the waterproof structure 1 of the present embodiment can suppress deterioration in sealability of the first seal portion 43 when the flexible portion 45 is deformed following the deformation of the corrugated tube 3.

The wire harness 100 of the present embodiment includes the electric wire 2 and the waterproof structure 1. Therefore, the wire harness 100 of the present embodiment can suppress infiltration of water between the grommet 4 and the corrugated tube 3 and improve the water-blocking performance.

The exterior member 5 inserted into the second tubular portion 42 is not limited to a corrugated tube having no slit. The exterior member 5 may be, for example, a corrugated tube having a slit or a twisted tube.

The shape of the flexible portion 45 is not limited to the illustrated cylindrical shape. The cross-sectional shape of the flexible portion 45 may be an elliptical shape or other shapes. The inner diameter D3 of the flexible portion 45 may not be constant. In this case, the shape of the flexible portion 45 may be a shape in which the inner diameter D3 changes along the first direction X like a cone.

### First Modification of Embodiment

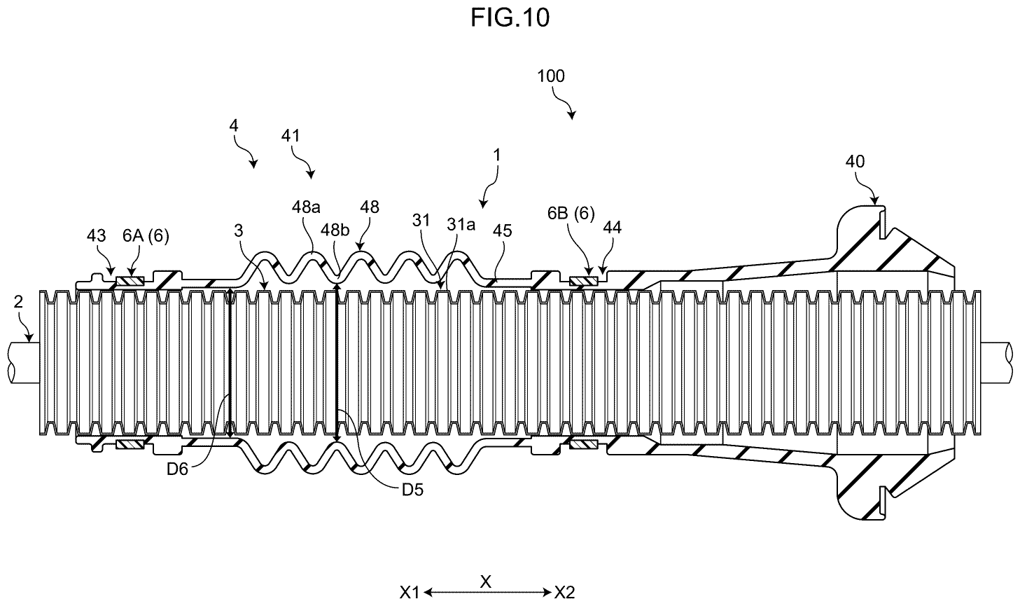

A first modification of the embodiment will be described with reference to FIG. 10. FIG. 10 is a view illustrating a waterproof structure and a wire harness according to a first modification of the embodiment. FIG. 10 illustrates a cross section of the grommet 4. The first modification of the embodiment is different from the above embodiment in that, for example, the first tubular portion 41 includes a bellows portion 48.

As illustrated in FIG. 10, the flexible portion 45 according to the first modification of the embodiment includes a bellows portion 48. The bellows portion 48 has a plurality of crest portions 48a and a plurality of valley portions 48b. An inner diameter D5 of the valley portion 48b is larger than the outer diameter D4 of the corrugated tube 3. The first tubular portion 41 having the bellows portion 48 has high followability to deformation of the corrugated tube 3. The first tubular portion 41 can mainly deform and follow the bellows portion 48 with respect to the bending deformation of the corrugated tube 3. Therefore, the grommet 4 of the first modification can appropriately suppress the displacement of the first seal portion 43 and the displacement of the second seal portion 44 with respect to the corrugated tube 3.

As described above, the flexible portion 45 according to the first modification of the embodiment includes the bellows portion 48 having a bellows shape. The innermost diameter of the flexible portion 45 is larger than the outer diameter D4 of the corrugated tube 3. Therefore, the waterproof structure 1 according to the first modification of the embodiment can improve followability of the flexible portion 45 against deformation of the corrugated tube 3. The innermost diameter of the flexible portion 45 may be the inner diameter D5 of the valley portion 48b or may be an inner diameter D6 of the portion adjacent to the bellows portion 48.

The contents disclosed in the above embodiments and modifications can be appropriately combined and executed.

In a waterproof structure according to the present embodiment, a first tubular portion of a grommet includes a first seal portion that protrudes toward a central axis line of the first tubular portion and is in close contact with an outer peripheral surface of a corrugated tube, a second seal portion that protrudes toward the central axis line and is in close contact with the outer peripheral surface of the corrugated tube, and a flexible portion that is disposed between the first seal portion and the second seal portion and is bendable. The waterproof structure according to the present embodiment has an effect of improving water-blocking performance.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A waterproof structure comprising:
a corrugated tube into which an electric wire is inserted; and
a grommet having a first tubular portion into which the corrugated tube is inserted and holding the corrugated tube, wherein
the first tubular portion includes a first seal portion that protrudes toward a central axis line of the first tubular portion and is in close contact with an outer peripheral surface of the corrugated tube, a second seal portion that protrudes toward the central axis line and is in close contact with the outer peripheral surface of the corrugated tube, and a flexible portion that is disposed between the first seal portion and the second seal portion and is bendable,
a crest portion of the corrugated tube has a top surface,
a length of the first seal portion and the second seal portion in the direction of the central axis line is a length capable of covering two adjacent top surfaces of the corrugated tube,
the grommet includes a fitting portion fitted to a through hole of a panel, and the fitting portion is disposed on a side opposite to a side of the first seal portion with respect to the second seal portion, and
a length of the first seal portion in the direction of the central axis line is larger than a length of the second seal portion.

2. The waterproof structure according to claim 1, wherein
the flexible portion has a bellows shape, and an innermost diameter of the flexible portion is larger than an outer diameter of the corrugated tube.

3. The waterproof structure according to claim 1, wherein
a tapered portion whose thickness changes is provided between the flexible portion and the first seal portion, and
a wall thickness of the tapered portion decreases with increasing distance from the first seal portion along the direction of the central axis line.

4. A wire harness comprising:
an electric wire;
a corrugated tube into which the electric wire is inserted; and
a grommet having a first tubular portion into which the corrugated tube is inserted and holding the corrugated tube, wherein
the first tubular portion includes a first seal portion that protrudes toward a central axis line of the first tubular portion and is in close contact with an outer peripheral surface of the corrugated tube, a second seal portion that protrudes toward the central axis line and is in close contact with the outer peripheral surface of the corrugated tube, and a flexible portion that is disposed between the first seal portion and the second seal portion and is bendable.
